(19) United States
(12) Patent Application Publication
(10) Pub. No.: US 2013/0018117 A1
(43) Pub. Date: Jan. 17, 2013

(54) MACHINABLE THERMALLY INSULATING POLYMERIC FOAM

(71) Applicants: Richard T. Fox, Midland, MI (US); David J. Frankowski, Freeland, MI (US); Roy E. Smith, Midland, MI (US); Simon Lee, Midland, MI (US)

(72) Inventors: Richard T. Fox, Midland, MI (US); David J. Frankowski, Freeland, MI (US); Roy E. Smith, Midland, MI (US); Simon Lee, Midland, MI (US)

(21) Appl. No.: 13/513,599

(22) PCT Filed: Dec. 2, 2010
(86) PCT No.: PCT/US10/58630

§ 371 Date: Jun. 4, 2012

Related U.S. Application Data
(60) Provisional application No. 61/292,670, filed on Jan. 6, 2010.

(51) Int. Cl. C08J 9/14; B29C 47/00

(52) U.S. Cl. 521/98; 264/50

(57) ABSTRACT

Provide a foamable polymer composition containing: (i) a thermoplastic polymer matrix and a blowing agent, (a) the thermoplastic polymer matrix containing a styrene-acrylonitrile copolymer having a weight-averaged molecular weight in a range of 90,000 to 150,000 and polymerized acrylonitrile concentration in a range of five to twenty weight-percent relative to total polymer matrix weight; and (ii) a blowing agent containing water, 1,1,1,2-tetrafluouroethane and at least one of difluoromethane and 1,1-dilluoroethane; (b) cooling the foamable polymer composition to a foaming temperature; and (c) extruding the foamable polymer composition and allowing the blowing agent to expand the foamable polymer composition into a polymeric foam having an average vertical cell size in a range of 0.5 millimeters to 1.8 millimeters and a density in a range of 24 to 40 kilograms per cubic meter and a Normalized Roughness Quotient of 3.5 or less in a Milled Surface Test.

### CROSS REFERENCE STATEMENT

This application claims the benefit of U.S. Provisional Application No. 61/292,670, filed Jan. 6, 2010, the entire content of which is incorporated herein by reference.

### BACKGROUND OF THE INVENTION

1. Field of the Invention

The present invention relates to polymeric foam articles that concomitantly have an exceptional machinability and low thermal conductivity properties, as well as a process for preparing such foam articles.

2. Description of Related Art

Extruded polystyrene (XPS) foam is commonly used as thermal insulation for many applications, including pipe insulation. Pipe insulation, however, is particularly challenging to make because it requires foam characteristics that differ from, for example, thermally insulating polymeric foam boards and sheets. Unlike most thermally insulating boards and sheets, machinability of pipe insulation foam is important so that fabricators can customize the pipe insulation for their particular application, a process that typically involves starting with a foam board, or “billet”, that is cut into smaller sizes and different shapes as needed to provide insulation around pipes.

Common to all thermal insulation foams is a low thermal conductivity through the foam. In order to achieve low thermal conductivity, thermally insulating foam desirably has a small average cell size. Ideally, cell sizes are on the order of nanometers in order to benefit from the Knudsen effect for enhancing thermal insulation properties. More commonly, thermally insulating foam has an average cell size of 300 micrometers or smaller. Pipe insulation foam, however, must balance small cell size for thermal conductivity with a need for machinability.

As mentioned, pipe insulation must be a good thermal insulator, but it also must be machinable. That is, pipe insulation foam must be able to be machined into shapes. Machinability, like thermal conductivity, is a function of cell size—but machinability is typically improved by increasing cell size. While typical thermally insulating foam has a cell size of 300 microns or less, foam having desirable machining characteristics typically has a cell size of one millimeter or more. Therefore, optimizing the properties of pipe insulation includes balancing high quality thermal insulating properties with high quality machinability properties. Historically, this balance was offset towards larger cell sizes for machinability and then hydrochlorofluorocarbons (HCFCs) such as chlorodifluoromethane (R-22) and 1-chloro-1,1-difluoroethane (R-142b) were used as blowing agents to improve the thermal insulating properties. However, the ozone depleting potential (ODP) of HCFCs has brought them under scrutiny and regulation around the world. An ODP of zero is desirable, yet R-22 has an ODP value of 0.05-0.04 and R-142b has an ODP value of 0.065.

It is desirable to develop an XPS foam that has a thermal conductivity at least as low as historical pipe insulation (that is, 32-37 mW/m*K 180 days after production) and good machinability, but that is made with blowing agents that have an ODP of zero.

### BRIEF SUMMARY OF THE INVENTION

Applicants have unexpectedly discovered a solution to the problem of how to prepare an XPS foam that has a thermal conductivity at least has low as historical pipe insulation (that is, 32-37 mW/m*K) and good machinability, but that is made with blowing agents having a ODP of zero.

In a first aspect, the present invention is a polymeric foam article comprising a thermoplastic polymer matrix defining multiple cells therein, wherein: (a) the thermoplastic polymer matrix comprises a styrene-acrylonitrile copolymer having a weight-averaged molecular weight in a range of 90,000 to 150,000 and polymerized acrylonitrile concentration in a range of five to twenty weight-percent relative to total polymer matrix weight; and (b) the polymeric foam contains 1,1,1,2-tetrafluoroethane and is free of blowing agents having an ozone depletion potential that is greater than zero; (c) the polymeric foam article has an average vertical cell size in a range of 0.5 millimeters to 1.8 millimeters and a density in a range of 24 to 40 kilograms per cubic meter; and (d) the polymeric foam has a Normalized Roughness Quotient of 3.5 or less in a Milled Surface Test.

In a second aspect, the present invention is an extrusion process for preparing the polymeric foam of the first aspect, the process comprising: (a) providing at an initial temperature and initial pressure a foamable polymer composition having a softening temperature and comprising: (i) a thermoplastic polymer matrix and a blowing agent, the thermoplastic polymer matrix comprising a styrene-acrylonitrile copolymer having a weight-averaged molecular weight in a range of 90,000 to 150,000 and polymerized acrylonitrile concentration in a range of five to twenty weight-percent relative to total polymer matrix weight; and (ii) a blowing agent comprising water, 1,1,1,2-tetrafluouroethane and at least one of difluoromethane and 1,1-difluoroethane and that optionally contains a hydrocarbon having from four to eight carbons but that is free of carbon dioxide and free of blowing agents having an ozone depletion potential that is greater than zero; wherein the initial temperature is above the softening temperature of the foamable polymer composition and the initial pressure is sufficiently high to preclude foaming by blowing agent expansion; (b) cooling the foamable polymer composition to a foaming temperature that is above the softening temperature of the foamable polymer composition if the initial temperature is above the foaming temperature; and (c) extruding the foamable polymer composition through a foaming die into a pressure below the initial pressure and sufficiently low to allow the blowing agent to expand the foamable polymer composition into a polymeric foam that has an average vertical cell size in a range of 0.5 millimeters to 1.8 millimeters and a density in a range of 24 to 40 kilograms per cubic meter and has a Normalized Roughness Quotient of 3.5 or less in a Milled Surface Test.

The process of the present invention is useful for preparing the polymeric foam article of the present invention. The polymeric foam article of the present invention is useful as a thermal insulating material, particularly for such materials requiring machining to custom shapes such as thermal insulating materials for pipes.

### DETAILED DESCRIPTION OF THE INVENTION

“Article” refers to a structure of any shape including a board or billet as well as a complex fabricated shape as may be necessary for a particular pipe insulating material.

“Primary surface” is a surface of foam having a planar surface area equal to the highest planar surface area of any surface of the foam. Planar surface area is the area of a surface as projected onto a plane so as to remove contributions to surface area by features such as bumps or depressions.

Length, Width, Thickness. The “length” of an extruded foam article is a dimension extending in the extrusion direction of the foam article. The “thickness” dimension of extruded foam article is a dimension extending perpendicular to a primary surface of the foam article and extending to a surface opposing the primary surface. The “width” dimension of extruded foam article is a dimension extending perpendicular to the extrusion direction and parallel to a primary surface of the foam article.

Ozone depletion potential (ODP). ODP is the ratio of the impact on ozone of a chemical compared to the impact of a similar mass of CFC-11. Fluorinated hydrocarbons have an ODP of zero since they do not contain chlorine. (see, www.epa.gov/Ozone/defns.html).

Global warming potential (GWP). GWP is the ratio of the warming caused by a substance to the warming caused by a similar mass of carbon dioxide. Hence, carbon dioxide has a GWP of 1.0. Water has a GWP of zero. (see, www.epa.gov/Ozone/defns.html).

“Fluorinated hydrocarbons” are hydrocarbons containing at least one fluorine atom. Fluorinated hydrocarbons include partially and completely fluorinated hydrocarbons that are free of chlorine. Partially fluorinated hydrocarbons still have at least one hydrogen atom attached to a carbon atom. Completely fluorinated hydrocarbons are free from hydrogen atoms attached directly to carbon atoms. Non-fluorinated hydrocarbons are hydrocarbons that do not contain a halogen.

“Softening temperature” (Tₛ) for a polymer or polymer composition having as polymer components only one or more than one semi-crystalline polymer is the melting temperature for the polymer composition.

“Melting temperature” (Tₘ) for a semi-crystalline polymer is the temperature half-way through a crystalline-to-melt phase change as determined by differential scanning calorimetry (DSC) upon heating a crystallized polymer at a specific heating rate. Determine Tₘ for a semi-crystalline polymer according to the DSC procedure in ASTM method E794-06. Determine Tₘ for a combination of polymers and for a filled polymer composition also by DSC under the same test conditions in ASTM method E794-06. If the combination of polymers or filled polymer composition only contains miscible polymers and only one crystalline-to-melt phase change is evident in its DSC curve, then Tₘ for the polymer combination or filled polymer composition is the temperature half-way through the phase change. If multiple crystalline-to-melt phase changes are evident in a DSC curve due to the presence of immiscible polymers, then Tₘ for the polymer combination or filled polymer composition is the Tₘ of the continuous phase polymer. If more than one polymer is continuous and they are not miscible, then the Tₘ for the polymer combination or filled polymer composition is the highest Tₘ of the continuous phase polymers.

Tₛ for a polymer or polymer composition having as polymer components only one or more than one amorphous polymer is the glass transition temperature for the polymer composition.

“Glass transition temperature” (T_{g}) for a polymer or polymer composition is as determined by DSC according to the procedure in ASTM method E1356-03. Determine T_{g} for a combination of polymer and for a filled polymer composition also by DSC under the same test conditions in ASTM method E1356-03. If the combination of polymer or filled polymer composition only contains miscible polymers and only one glass transition phase change is evident in the DSC curve, then T_{g} of the polymer combination or filled polymer composition is the temperature half-way through the phase change. If multiple glass transition phase changes are evident in a DSC curve due to the presence of immiscible amorphous polymers, then T_{g} for the polymer combination or filled polymer composition is the T_{g} of the continuous phase polymer. If more than one amorphous polymer is continuous and they are not miscible, then the T_{g} for the polymer composition or filled polymer composition is the highest T_{g} of the continuous phase polymers.

If the polymer composition contains a combination of semi-crystalline and amorphous polymers, the softening temperature of the polymer composition is the softening temperature of the continuous phase polymer or polymer composition. If the semi-crystalline and amorphous polymer phases are co-continuous, then the softening temperature of the combination is the higher softening temperature of the two phases.

“Normalized Roughness Quotient” is a property of a polymeric foam article that provides an indication of the machinability of the polymeric foam article. Determine Normalized Roughness Quotient using the following Milled Surface Test: (1) Mill a flat surface 0.25 inches deep into an extruded polymeric foam sample using a 0.75 inch diameter two-lip end mill bit at 70 revolutions per minute with no coolant in a single pass that traverses the foam sample at a rate of 3-4 inches per minute along the extrusion direction of the foam; (2) characterize the roughness of the resulting flat surface by determining an Ra value using stylus profilometry with a Veeco Dektak 150 Stylus instrument and a 12.5 micrometer radius diamond tip (60° cone) stylus along a one centimeter length in the extrusion direction of the foam sample while applying a stylus force of 1.0 milligrams, a scan time of 16 seconds, a scan speed of 63 micrometers per second, a sampling rate of 300 hertz and a resolution of 2.1 micrometers per point; (3) repeat step (2) on the same foam but on a surface whose skin has been skived off using a meat-slicer (Hobart model 410 meat slicer); and (4) obtain a Normalized Machine Roughness Quotient by taking a ratio of the roughness value obtained in step (2) to that obtained in step (3). The Normalized Roughness Quotient provides an indication of how smooth a machined surface is after milling relative to the smoothness of a surface of the foam after skiving with a meat slicer.

“ASTM” refers to American Society for Testing and Materials. All references to standard test methods such as ASTM methods refer to the most current test method as of the filing of this application unless otherwise indicated. Test methods may include a date as a hyphenated suffix to the test number.

Ranges include endpoints. “And/or” means “and, or as an alternative”.

The process of the present invention is an extrusion foam process. Extrusion foam processes require extruding a foamable polymer composition out from an extruder after which the foamable polymer composition expands into a foam. The foamable polymer composition comprises a polymer matrix material and an expansion agent (for example, a blowing agent).

The polymer matrix in the foamable polymer composition has a softening temperature and comprises a polymer component having a softening temperature. The polymer component accounts for all of the polymers in the polymer matrix and comprises at least one styrene-acrylonitrile copolymer (SAN). The polymer component is more than 50 weight-percent (wt %), preferably 75 wt % or more, more preferably 90 wt % or more, still more preferably 95 wt % or more and can be 100 wt % SAN. The polymer component may contain more than one type of polymer including combinations of different SAN copolymers or combinations of different polymers (such as polystyrene) with SAN. Desirably, the polymer component comprises only SAN. Desirably, all of the polymers in the polymer component are thermoplastic. Preferably 75 wt % or more, more preferably 90 wt % or more and even more preferably all of the polymers in the polymer component are thermoplastic. Weight-percent is relative to total polymer component weight.

The SAN in the polymer component (whether the polymer component is entirely SAN or a combination of SAN with another polymer) has a weight averaged molecular weight (Mw) of 90,000 grams per mole (g/mol) or more, preferably 95,000 g/mol or more, still more preferably 100,000 g/mol or more, even more preferably 110,000 g/mole or more. When the Mw is below 90,000 grams per mole the resulting foam tends to be more friable than is desirable. Furthermore, the SAN desirably has a Mw of 150,000 grams per mole or less. When the polymer has a Mw greater than 150,000 the polymer tends to perform poorly in the machinability test. The amount of copolymerized acrylonitrile monomer (AN) in the SAN is 5 wt % or more, preferably 10 wt % or more, more preferably 12 wt % or more and at the same time 25 wt % or less, preferably 20 wt % or less based on total SAN weight.

The polymer matrix may include in addition to the polymer component any one or combination of more than one additive. Any additive suitable for use in foam is also suitable for use in the present invention. Examples of suitable classes of additives include infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); flame retardants (for example, brominated flame retardants such as hexabromocyclododecane and brominated polymers, phosphorous flame retardants such as triphenylphosphate, and flame retardant packages that may including synergists such as, or example, dicumyl and polycumyl); lubricants (for example, calcium stearate and barium stearate); and acid scavengers (for example, magnesium oxide and tetrasodium pyrophosphate).

The selection of expansion agent in the foamable polymer composition is essential to the present invention. The expansion agent (or “blowing agent”) comprises water, 1,1,1,2-tetrafluoroethane (HFC-134a) and at least one of a group consisting of difluoromethane (HFC-32) and 1,1-difluoroethane (HFC-152a). The blowing agent optionally contains (which means it may contain or may be free of) one or more non-halogenated hydrocarbon selected from those having from four to eight carbons. Moreover, the expansion agent is free of any blowing agents having an ODP greater than zero and is desirably free of any blowing agents having a global warming potential (GWP) that is greater than 1500, preferably greater than 1350. Still more, the blowing agent is desirably free of carbon dioxide, which has a tendency to promote small cell sizes that cause the resulting foam to have poor machinability characteristics. In one embodiment, the blowing agent consists of water, HFC-134a and at least one of HFC-32 and HFC-152a and optionally one or more non-halogenated hydrocarbon selected from those having from four to eight carbons. In one embodiment the blowing agent consists of water, HFC-134a and at least one of HFC-32 and HFC-152a. The blowing agent can be free of HFC-32 or, alternatively, HFC-152a.

Water is important in the blowing agent to promote large cell sizes, which are desirable for machinability. HFC-134a, HFC-32 and/or HFC-152a are important to provide low thermal conductivities through the resulting foam but without nucleating extensively to produce small cell sizes. Many HFCs can contribute to thermal insulating properties of a foam, but also are strong nucleators that promote small cell size formation. HFC-32 and HFC-152a are important because they can be present in high concentrations without nucleating excessively during foaming, thereby enabling expansion to low densities without inducing small cell sizes. HFC-134a is necessary because it promotes long-term thermal insulating properties to the foam by remaining in the foam longer than HFC-32 and/or HFC-152a. Small cell sizes are not desirable for the present invention since foams with small cell sizes generally machine poorly.

The total amount of blowing agent in the foamable polymer composition is generally 0.9 gram-moles or more, preferably 1.1 gram-moles or more while also generally being 1.6 gram-moles or less, preferably 1.4 gram-moles or less. Gram-moles are relative to one kilogram of polymer. Of the total amount of blowing agent water is generally present in a range of 0.1 to 0.6 g-moles per kilogram of polymer, HFC-134a is typically present in a range of 0.3 to 0.6 g-moles per kilograms of polymer and the combined concentration of HFC-32 and HFC-152a is typically in a range of 0.3 to 0.7 gram-moles per kilogram polymer, regardless of whether both HFC-32 and HFC-152a are present or either one individually. Non-halogenated hydrocarbons with four to eight carbons can be present at a concentration of 0.1 to 0.6 gram-moles per kilogram polymer.

Provide the foamable polymer composition in an extruder at an initial temperature and pressure. Any or all of the components in the foamable polymer composition may be added and mixed into the foamable polymer composition within the extruder. The initial temperature is higher than the softening temperature of the polymer component so that the other components of the foamable polymer composition may be mixed within the polymer composition in the extruder. The initial pressure is sufficiently high so as to preclude expansion of the expansion agent and foaming of the matrix material. A generally acceptable method of providing the foamable polymer composition in an extruder is by feeding polymer and any desirable additives into an extruder that heats the polymer above its softening point and then injecting foaming agent into the polymer at a pressure no lower than the initial pressure. The extruder then assists in mixing the components together to create a generally homogeneous foamable polymer composition.

Expel the foamable polymer composition into an environment at a pressure lower than the initial pressure and allow the expanding agent to foam the foamable polymer composition. The temperature of the foamable polymer composition can be adjusted higher or lower than the initial temperature prior to expelling provided that the average temperature of polymer composition during expelling is above the softening temperature of the polymer composition.

Expand the foamable polymer composition into polymer foam having a density of 40 kg/m³ or less, preferably 35 kg/m³ or less, more preferably 32 kg/m³ or less, and even 30 kg/m³ or less and desirably 24 kg/m³ or more.

The polymer foam also desirably has an average cell size of 0.5 millimeters or more, preferably one millimeter or more and at the same time typically two millimeter or less, preferably 1.8 millimeters or less and most preferably 1.5 mm or less. Large cell sizes machine well, but smaller cell sizes provide better thermal insulation. The present combination of polymer and blowing agent allows for a balance of the cell size such that machinability and thermal insulation capability are better than other SAN-containing foams.

Surprisingly, the process of the present invention provides a polymeric foam article of the present invention. In addition to those properties of the foam already identified above, the polymeric foam article has a thermal conductivity of 37 milliWatts per meter*Kelvin (mW/m*K) or less, preferably 35 mW/m*K or less. The polymeric foam article also has a Normalized Roughness Quotient that is less than 3.5, preferably 3.0 or less, still more preferably 2.5 or less, yet more preferably 2.0 or less and still more preferably 1.5 or less. That means the polymeric foam article has a desirable balance of thermal insulating properties and machinability. Generally, the thermal conductivity of the resulting foam is 30 mW/m*K or more and can be 32 mW/m*K or more in addition to those properties already mentioned. Measure thermal conductivity according to ASTM method C-518 180 days after production.

Expel the foamable polymer composition in any manner suitable for extruded foam manufacturing. For example, accumulator extrusion processes, coalesced strand processes, foam sheet and foam plank processes are all suitable for use in the present invention.

The polymeric foam article comprises a thermoplastic polymer matrix defining multiple cells therein. The thermoplastic polymer matrix is as described for the polymer matrix of the process of the present invention. Due to the process of the present invention being free of blowing agents having an ozone depletion potential that is greater than zero, the foam of the present invention also is free of blowing agents having an ODP that is greater than zero. The polymeric foam article of the present invention has an average density, average cell size and Normalized Roughness Quotient as described for the foam produced by the process of the present invention.

Due to the process of the present invention, the foam of the present invention contains HFC-134a. The amount of HFC-134a at any given time will vary since it gradually escapes from the foam, but its presence is detectable for well over ten years after manufacturing. HFC-152a and HFC-32 are also detectable in a foam after production, but for a lesser period of time.

### EXAMPLES

The following examples illustrate embodiments of the present invention.

### Example 1

Water, HFC134a and HFC32. Prepare a polymeric foam article by first blending a combination of two SAN copolymers, one with a weight-averaged molecular weight (Mw) of 144,000 g/mol and the other with a Mw of 118,000 g/mol and both with 15 wt % copolymerized acrylonitrile monomer. Combine the copolymers at a ratio of 70 wt % 118,000 g/mol polymer and 30 wt % 144,000 g/mol polymer. Blend the copolymers together in the extruder at an initial temperature of 200° C. Further blend in the following additives: polyethylene (0.2 weight part per hundred weight parts total copolymer (pph)), barium stearate (0.01 pph), talc (0.08 pph), flame retardant package comprising hexabromocyclododecane, Irganox® B215 and ECN1280 in a 7:1:1 ratio (0.95 pph) (Irganox is a trademark of CIBA Specialty Chemicals, Corp.). Blend this mixture (virgin composition) together with recycled polymer foam prepared in like manner to Example 1 at a ratio of 75 wt % virgin composition and 25 wt % recycled polymer foam.

Mix into the blend the following blowing agents: water (one pph), HFC-134a (5 pph) and HFC-32 (two pph) at an initial pressure of 17.2 mega Pascals (MPa). The resulting blend is a foamable polymer composition.

Cool the foamable polymer composition to a foaming temperature of approximately 119° C. and extrude through a rectangular foaming die having opening dimensions of approximately 1.3 centimeters by 15.2 centimeters into atmospheric pressure and temperature (approximately 21° C. and one atmosphere of pressure). Allow the extruded foamable polymer composition to expand into a polymeric foam article having a thickness of 20.2 centimeters (8 inches), a width of 40.6 centimeters, an average cell size of 1.51 millimeters, and a density of 31.2 kg/m³ (1.95 pounds per cubic foot (pcf)).

Characterize the machinability of the resulting polymeric foam article (Ex 1) by Normalized Roughness Quotient as determined by the Milled Surface Test. Ex 1 has a Normalized Roughness Quotient of 1.28.

Characterize the thermal conductivity of Ex 1 according to ASTM C-518 at 180 days. Ex 1 has a thermal conductivity of 33.8 mW/m*K.

Ex 1 illustrates an embodiment of the present invention using HFC-32.

### Example 2

Water, HFC134a and HFC152a. Prepare polymeric foam samples in like manner to Ex 1 except use 2 pph HFC-152a instead of HFC-32 and use 5.5 pph instead of 5 pph of HFC-134a. The resulting polymeric foam article (Ex 2) has an average cell size of 1.26 millimeters, a density of 29.8 kg/m³ (1.86 pcf), a Normalized Roughness Quotient of 1.58 and a thermal conductivity value of 31.9 mW/m*K at 180 days.

Ex 2 illustrates an embodiment of the present invention using HFC-152a. Examples 1 and 2 illustrate an ability to prepare the polymeric foam article of the present invention using either HFC-32 or HFC-152a.

Similar results to that of Ex 1 and Ex 2 are anticipated for polymeric foam article prepared in like manner using 100% virgin polymer composition or any blend of virgin polymer composition and recycled polymer composition between 100:0 and 60:40 virgin:recycled weight-ratios.

1. A polymeric foam article comprising a thermoplastic polymer matrix defining multiple cells therein, wherein:
a. the thermoplastic polymer matrix comprises a styrene-acrylonitrile copolymer having a weight-averaged molecular weight in a range of 90,000 to 150,000 and polymerized acrylonitrile concentration in a range of five to twenty weight-percent relative to total polymer matrix weight; and
b. the polymeric foam contains 1,1,1,2-tetrafluoroethane and is free of blowing agents having an ozone depletion potential that is greater than zero;
c. the polymeric foam article has an average vertical cell size in a range of 0.5 millimeters to 1.8 millimeters and a density in a range of 24 to 40 kilograms per cubic meter; and
d. the polymeric foam has a Normalized Roughness Quotient of 3.5 or less in a Milled Surface Test.

2. The polymeric foam article of claim 1, wherein the average cell size is in a range of one to 1.5 millimeters.

3. The polymeric foam article of claim 1, wherein the thermoplastic polymer matrix comprises a blend of two or more styrene-acrylonitrile copolymers, each having a weight-averaged molecular weight in a range of 90,000 to 150,000 and wherein the total amount of copolymerized acrylonitrile is five to twenty weight-percent relative to total polymer matrix weight.

4. An extrusion process for preparing the polymeric foam of claim 1, the process comprising:
a. providing at an initial temperature and initial pressure a foamable polymer composition having a softening temperature and comprising:
i. a thermoplastic polymer matrix and a blowing agent, the thermoplastic polymer matrix comprising a styrene-acrylonitrile copolymer having a weight-averaged molecular weight in a range of 90,000 to 150,000 and polymerized acrylonitrile concentration in a range of five to twenty weight-percent relative to total polymer matrix weight; and
ii. a blowing agent comprising water, 1,1,1,2-tetrafluouroethane and at least one of difluoromethane and 1,1-difluoroethane and that optionally contains a hydrocarbon having from four to eight carbons but that is free of carbon dioxide and free of blowing agents having an ozone depletion potential that is greater than zero;
wherein the initial temperature is above the softening temperature of the foamable polymer composition and the initial pressure is sufficiently high to preclude foaming by blowing agent expansion;
b. cooling the foamable polymer composition to a foaming temperature that is above the softening temperature of the foamable polymer composition if the initial temperature is above the foaming temperature; and
c. extruding the foamable polymer composition through a foaming die into a pressure below the initial pressure and sufficiently low to allow the blowing agent to expand the foamable polymer composition into a polymeric foam that has an average vertical cell size in a range of 0.5 millimeters to 1.8 millimeters and a density in a range of 24 to 40 kilograms per cubic meter and has a Normalized Roughness Quotient of 3.5 or less in a Milled Surface Test.

5. The process of claim 4, wherein expansion in step (c) produces a polymeric foam article having an average cell size is in a range of one to 1.5 millimeters.

6. The process of claim 4, further characterized as being free of carbon dioxide blowing agent.

7. The process of claim 4, wherein the blowing agent is free of hydrocarbons having from four to eight carbons.

8. the process of claim 4, wherein the blowing agent consists of water, 1,1,1,2-tetrafluouroethane and at least one of difluoromethane and 1,1-difluoroethane and optionally a hydrocarbon having from four to eight carbons.

9. The process of claim 8, wherein the blowing agent is free of hydrocarbons having from four to eight carbons.
